(19) United States
(12) Patent Application Publication
(10) Pub. No.: US 2026/0077499 A1
(43) Pub. Date: Mar. 19, 2026

(54) Method for a Dynamic Control of a Robot Device for an Efficient Handling of a Product

(71) Applicant: ABB Schweiz AG, Baden (CH)

(72) Inventors: Mikael Alhadeff, Braine l'Alleud (BE); Tom Blondeel, Halle (BE); Willem Vanderhoydonk, Halle (BE)

(73) Assignee: ABB Schweiz AG, Baden (CH)

(21) Appl. No.: 19/395,069

(22) Filed: Nov. 20, 2025

Related U.S. Application Data
(63) Continuation of application No. PCT/EP2023/064206, filed on May 26, 2023.

(51) Int. Cl. B25J 9/16

(52) U.S. Cl. CPC B25J 9/1664

(57) ABSTRACT

A method for dynamic control of a robot device for an efficient handling of a product includes determining a product parameter relating to a characteristic property of the product; determining a robot parameter relating to a characteristic property of the robot; assigning a first weight parameter of the product to the product and/or robot parameter, and generating an equivalent product output value; comparing the product output value with a reference product output value of a reference product parameter of a reference product based on at least one characteristic property of the reference product; determining an adjustment factor based on the result of the compared output values that will be used compute a corresponding configuration parameter of the robot device to control the robot device for handling the product in a customized way.

### CROSS-REFERENCE TO RELATED APPLICATIONS

The instant application claims priority to International Patent Application No. PCT/EP2023/064206, filed May 26, 2023, which is incorporated herein in its entirety by reference.

### FIELD OF THE DISCLOSURE

The present disclosure generally relates to a method for a dynamic control of a robot device for an efficient handling of a product.

### BACKGROUND OF THE INVENTION

In a logistic pick and place application, a large distribution of items or products need to be handled with the same robot device and hardware. For example, the logistic robot device performs a full mixed depalletizing or item picking. The items to be handled by the robot device vary from blisters, polybags, cardboard boxes, bottles, food and non-food items etc.

Currently, the acceleration or speed of an item manipulation is fine-tuned case by case to optimize the speed of the robot device when attached to a robotic gripper of the robot device. For example, a compact and lightweight item which is firmly gripped by 3 suctions cups will withstand high accelerations for better then a large and heavy item, which is gripped with only one suction cup and of which the center of gravity is far away from the gripper itself.

In the prior art, mathematical formulas are used in order to determine how an item or product needs to be handled depending on certain parameters such as weight, center of gravity, amount of section cups etc. The issue with these types of formulas is, however, that they do require customization for each specific application or item picking process.

Hence, as the control of the robot device distributing these items needs to be adapted according to each item processed by the robot device, a process of distributing items by the robot device is time-consuming and not efficient.

### BRIEF SUMMARY OF THE INVENTION

The present disclosure generally describes an improved control concept for a robot device for an efficient handling of an item or a product by the robot device. In a first aspect, there is provided a method for a dynamic control of a robot device for an efficient handling of a product, comprising the steps: determining at least one product parameter relating to a characteristic property of the product; determining at least one robot parameter relating to a characteristic property of the robot; assigning at least a first weight parameter of the product to the at least one product parameter and / or to the at least one robot parameter and generating an equivalent product output value; comparing the product output value with a reference product output value of a least one reference product parameter of a reference product based on at least one characteristic property of the reference product; and determining an adjustment factor based on the result of the compared output values that will be used compute a corresponding configuration parameter of the robot device to control the robot device for handling the product in a customized way.

In other words, a core idea behind the present invention is to implement a configurable or customizable setup of product-dependent speed modulation or speed control for a robot device when picking or processing items, e.g. for a logistic application. In this way, an optimized and efficiently controlled logistic robot device with optimized performance is obtained. Speed modulation that is not highly configurable will lead to a lower cycle-time, because certain products will be handled at lower speeds or accelerations then required. Therefore, one goal to be addressed by the present invention is to achieve an efficient and dynamic control of a performance parameter of the robot device when handling a product, e.g. speed/acceleration of a robot device, while maintaining a very broad item distribution.

Embodiments according to the disclosure achieve this goal by considering and introducing (a) reference product(s) when optimizing a performance parameter of the robot device for controlling the robot device. These reference product(s) symbolizes the “average product” of the customer. This creates a fully configurable setup.

Hence, in the speed modulation formula that is used for controlling the robot device, the concept of “weights” is introduced, where every part of this formula can have its own weights attached, e.g. suction cups, inertias, item weight, off-set, and the like). Configuring these weights with reference product(s) will then create a formula the is optimized for the complete item set of the customer and allows an optimized control of the robot device for handling the product or item in a more efficient manner.

The present invention provides various advantages. For instance, the configurable setup is generic, it works for a wide variation of applications and also for a wide product distribution. No programming is required, only configuration/parametrization of the robot device. By using a reference product or function, the fine tuning of a specific customer or project can be setup easily. Every possible parameter can be added to this setup as a standard. By not configuring parameters they will not used, which optimizes the use of the available customer master data. Customization is easily achieved via the parameters and the corresponding weights to these parameters. Reduced engineering, commissioning and testing in regard to speed modulation. More efficient pick place cycles are achieved and less products will be lost during robot movements. Higher overall efficiency and speed of a robotic device is achieved.

According to an example, the characteristic property of the least one product parameter of the product is at least one of a dimension of the product, a material or a weight of the product, a number of dynamic movable parts of the product. In this way, the control of the robot device is adopted in an efficient way to the product, ensuring an efficient robot control process.

According to an example, the characteristic property of the at least one robot parameter is at least one of type of suction, number of suctions. In this way, the advantage of an efficient control of the robot device is achieved.

According to an example, the at least product parameter and / or the at least robot parameter is based on an externally or internally provided customer information. In this way, an efficient control of the robot device is achieved when real requirements of product to be handled are considered.

According to an example, the reference output value is calculated on basis of a reference function. In this way, the advantage of an efficient adaption of the control of the robot device is achieved.

According to an example, the configuration parameter is at least one of a speed value or an acceleration value of the robot device. In this way, the robot device is controlled in an efficient manner.

In a second aspect, a computer comprising a processor configured to perform the method according to the first aspect is provided.

In a third aspect, a computer program product is provided comprising instructions which, when the computer program is executed by a processor of a computer, causes the computer to control the method of the first aspect.

In a fourth aspect, a machine-readable data medium and / or download product is provided containing the computer program according to the third aspect.

### BRIEF DESCRIPTION OF THE SEVERAL VIEWS OF THE DRAWINGS

FIG. 1 is a schematic flow-diagram of a method in accordance with the disclosure.

FIG. 2 is a diagram of a parametrization setup for controlling a robot device according to an embodiment of the present disclosure.

### DETAILED DESCRIPTION OF THE INVENTION

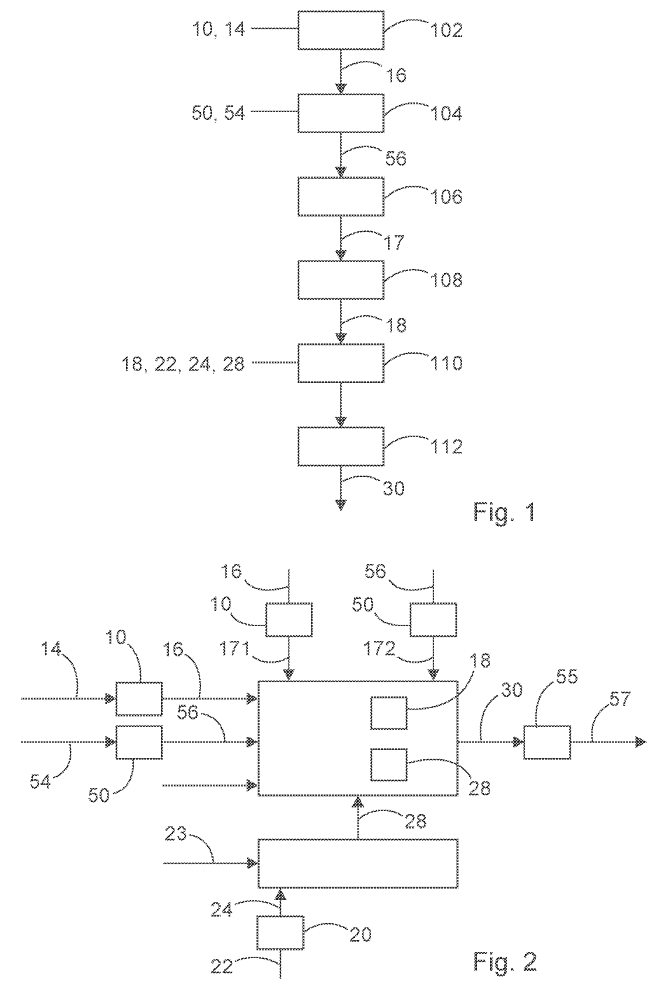

FIG. 1 illustrates a schematic flow-diagram of a method 100 for a dynamic control of a robot device 50 for an efficient handling of a product 10. In the following, also reference is made to the embodiment of FIG. 2, where useful for understanding the scope of the present invention.

In a first step 102, at least one product parameter 16 relating to a characteristic property 14 of the product 10 is determined. The characteristic property 14 may also include physical attributes of the product 10, e.g. a material or whether the product is fragile etc.

Optionally, the at least product parameter 16 and / or the at least robot parameter 56 is based on an externally or internally provided customer information. This aspect can be important because depending on a capacity or technical skills of the robot device 50 – e.g. having no vision or camera system - it might not be possible to detect the product characteristics and therefore, the customer is needed to provide this required product information.

Optionally, the characteristic property 14 of the least one product parameter 16 of the product 10 is at least one of a dimension of the product 10, a material or a weight of the product 10, a number of dynamic movable parts of the product 10. This list is not restricted to these examples, however.

In this respect, it should be noted that the input parameters are set of every relevant parameter that will impact the robot cell capacity or the robot device, e.g. weight, center of gravity, product type, amount of suction cups, moment of inertia, and so on. This list is not limited. The use of these parameters is configurable. This means that a commissioning engineer of a specific project is not required to write any code but only has to change some parameters of the product and / or parameters of the robot device. In a second step 104, at least one robot parameter 56 relating to a characteristic property 54 of the robot 50 is determined.

The robot parameter 56 can be for example a gripper of the robot device 50. The characteristic property 54 can be, for example, anything that would make the product handling for the robot device 50 different, e.g. the number of suction cups, their size, the vacuum power, the footprint of all the enabled cups etc. Optionally, the characteristic property 54 of the at least one robot parameter 56 is for example at least one of type of suction, number of suctions.

In a third step 106, at least a first weight parameter 17, 171, 172 of the product 10 to the at least one product parameter 16 and / or to the at least one robot parameter 56 is assigned. According to FIG. 2, the first weight parameter 171 is assigned based on the product parameter 16 and a second weight parameter 172 is assigned based on the robot parameter 56. One of these weight parameters or both weight parameters 171, 172 can be used for generating the equivalent product output value 18.

The relevance of item properties can vary between projects. Hence, the weight of specific properties can also be different in one and the same project. Therefore, a weight for each parameters can be used. This is easily configurable and does not require any code.

In a fourth step 108, an equivalent product output value 18 is generated. In this context, it should be noted that only output values are computed using same characteristics or weights. In a fifth step 110, the product output value 18 with a reference product output value 28 of a least one reference product parameter 24 of a reference product 20 based on at least one characteristic property 22 of the reference product 20 is compared. Optionally, the reference output value 28 is calculated on basis of a reference function 23, as shown for example in FIG. 2.

In a sixth step 112, an adjustment factor 30 based on the result of the compared output values 18, 28 is determined that will be used compute a corresponding configuration parameter 57 of the robot device 50 to control the robot device 50 for handling the product 10 in a customized way.

The adjustment factor 30 is determined based on a formula. The specific formula used for the configurable speed modulation is not relevant for the present disclosure. Many integrators use similar formulas but lack the relevant setup possibilities. What is relevant for the present invention is that it is a weighted formula with configurable parameters and weight parameters and which uses a reference value or a reference function as a base value.

The configuration parameter 57 can be for example a speed or acceleration of the robot device 50 and is the result or parameter needed to control or to adapt the control of the robot device 50 (see FIG. 2). The adjustment factor 30 is in this context the impact of the robot parameters 56, e.g. the number of cups or their sizes.

Further, the adjustment factor 30 represents a normalized number which is relative to the reference product output value 28 and can be, for example, used to adjust a speed, an acceleration, motion path etc. of the robot device 50.

FIG. 2 illustrates a parametrization setup for controlling a robot device according to an embodiment of the present invention. In principle, the FIG. 2 is just an more comprehensible version of the method 100 for a dynamic control of the robot device 50. Therefore, repetitions are avoided.

The embodiment of FIG. 2 also shows an important aspect of the present invention: All essential or required attributes of the product 10 are obtained and compute the product output value 18. This product output value 18 is then compared to the reference output value 28 which was computed using the same method but on the attributes of a reference product 20 that will be defined during the commissioning of the robot device 50 and will probably be different for every customer. FIG. 2 shows that the reference output value 28 is calculated on basis of a reference function 23.

In respect to the reference product, the following should be said. The reference product(s) is of high importance in this present invention. It serves as the base value for the entire speed modulation process or setup or the configurable control of performance parameter of and for the robot device 50. The product 20 that is specified as reference product should be the average product that can be handled at 100% speed or acceleration.

It is important that the reference should be determined for each individual setup of the robot device 50, so that the speed modulation is optimized for the entire product spectrum. This would mean testing with a set products of the specific customer, that will represent the whole spectrum. Further, the reference product is not necessarily limited to only one parameter, a variety of parameters can be used, which will result in a multidimensional scatter plot. A selection within such a scatter plot could be made with a reference function 23 (see FIG. 2). The reference function 23 then serves as the input for the reference product 20.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Reference Signs

10 Product / Object

14 Characteristic property of the product

16 Product parameter

17, 171, 172 Weight parameter

18 Product output value

20 Reference product

22 Characteristic property of the reference product

23 Reference function

24 Reference product parameter

28 Reference product output value

50 Robot device

54 Characteristic property of the robot

56 Robot parameter

57 Configuration parameter of the robot device

100 Method

102 Determining

104 Determining

106 Assigning

108 Generating

110 Comparing

112 Determining

What is claimed is:

1. A method for a dynamic control of a robot device for an efficient handling of a product, comprising:
determining at least one product parameter relating to a characteristic property of the product;
determining at least one robot parameter relating to a characteristic property of the robot;
assigning at least a first weight parameter of the product to the at least one product parameter and/or to the at least one robot parameter, and generating an equivalent product output value;
comparing the product output value with a reference product output value of a least one reference product parameter of a reference product based on at least one characteristic property of the reference product; and
determining an adjustment factor based on the result of the compared output values that will be used to compute a corresponding configuration parameter of the robot device to control the robot device for handling the product in a customized way.

2. The method according to claim 1, wherein the characteristic property of the least one product parameter of the product is at least one of a dimension of the product, a material or a weight of the product, and several dynamic movable parts of the product.

3. The method according to claim 1, wherein the characteristic property of the at least one robot parameter is at least one of type of suction, number of suctions, dimensions of the robot, and weight of the robot.

4. The method according to claim 1, wherein the at least product parameter and/or the at least robot parameter is based on an externally or internally provided customer information.

5. The method according to claim 1, wherein the reference output value is calculated based on a reference function.

6. The method according to claim 1, wherein the configuration parameter is at least one of a speed value or an acceleration value of the robot device.

7. A computer program product comprising instructions which, when the computer program is executed by a processor of a computer, causes the computer to perform a method for a dynamic control of a robot device for an efficient handling of a product, comprising:
instructions for determining at least one product parameter relating to a characteristic property of the product;
instructions for determining at least one robot parameter relating to a characteristic property of the robot;
instructions for assigning at least a first weight parameter of the product to the at least one product parameter and/or to the at least one robot parameter, and instructions for generating an equivalent product output value;
instructions for comparing the product output value with a reference product output value of a least one reference product parameter of a reference product based on at least one characteristic property of the reference product; and
instructions for determining an adjustment factor based on the result of the compared output values that will be used to compute a corresponding configuration parameter of the robot device to control the robot device for handling the product in a customized way.

8. The computer program product of claim 7, wherein the characteristic property of the least one product parameter of the product is at least one of a dimension of the product, a material or a weight of the product, and several dynamic movable parts of the product.

9. The computer program product of claim 7, wherein the characteristic property of the at least one robot parameter is at least one of type of suction, number of suctions, dimensions of the robot, and weight of the robot.

10. The computer program product of claim 7, wherein the at least product parameter and/or the at least robot parameter is based on an externally or internally provided customer information.

11. The computer program product of claim 7, wherein the reference output value is calculated based on a reference function.

12. The computer program product of claim 7, wherein the configuration parameter is at least one of a speed value or an acceleration value of the robot device.
